(19) United States
(12) Patent Application Publication
(10) Pub. No.: US 2002/0059216 A1
(43) Pub. Date: May 16, 2002

(54) Decision support system and method

(76) Inventors: Richard C. Gowen, Marietta, GA (US); Wayne Akins, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/825,436

(22) Filed: Apr. 2, 2001

Related U.S. Application Data
(60) Provisional application No. 60/193,740, filed on Mar. 31, 2000.

(51) Int. Cl. G06F 7/00

(52) U.S. Cl. 707/4

(57) ABSTRACT

The present invention provides a system and method for providing decision support. In architecture, the system includes an input mechanism that acquires system data, and a transformation mechanism that transforms the system data into searchable data. A reporter then provides queries on the searchable data. The present invention can also be viewed as a method for providing decision support. The method operates by acquiring system data; transforming the system data into searchable data; and providing queries on the searchable data.

### CLAIM OF PRIORITY AND CROSS REFERENCE TO RELATED APPLICATIONS

This application claims the benefit of U.S. Provisional Patent Application entitled “Decision Support System,” filed Mar. 31, 2000 and having Ser. No. 60/193,740 which is now pending and is incorporated herein by reference.

### FIELD OF THE INVENTION

The present invention generally relates to computers and computer software, and more particularly, to a system and method for supporting decisions.

### DESCRIPTION OF RELATED ART

Typically, in today's computing and database environments, if a user wishes to perform a query the appropriate program used is a structured query language (SQL). However, drawbacks with SQL are that the user must be a fairly competent programmer in order to utilize the language since it can be highly technical for some searches. Furthermore, because of the technical nature of SQL, most databases require a database administrator to collect and categorize the information collected. Because SQL is a generic query language system, the data is not focused on particular topics.

### SUMMARY OF THE INVENTION

The present invention provides a system and method for providing a decision support system. Briefly described, in architecture, the system of the preferred embodiment can be implemented as follows. The system includes an input mechanism that acquires system data, and a transformation mechanism that transforms the system data into searchable data. A reporter then provides queries on the searchable data.

The present invention can also be viewed as a method for providing decision support. The method operates by (1) acquiring system data; (2) transforming the system data into searchable data; and (3) providing queries on the searchable data.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

The accompanying drawings incorporated in and forming a part of the specification illustrate several aspects of the present invention, and together with the description, serve to explain the principles of the invention. Moreover, in the drawings, like reference numerals designate corresponding parts throughout the several views.

FIG. 1 is a block diagram illustrating an example of a network in which the decision support system may be implemented.

FIG. 2 is a block diagram illustrating an example of a computer system utilizing the decision support system, including the data distraction, staging area, data transformation and load, usage data mark, billing data mark, online queries and report and the installation decision support system of the present invention.

FIG. 3 is a block diagram illustrating an example of the architecture of the decision support system and its interaction with other components, including the billing system.

FIG. 4 is a flow diagram illustrating an example of the process flow of the decision support system of the present invention as illustrated in FIGS. 2 and 3.

### DETAILED DESCRIPTION OF THE PREFERRED EMBODIMENT

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

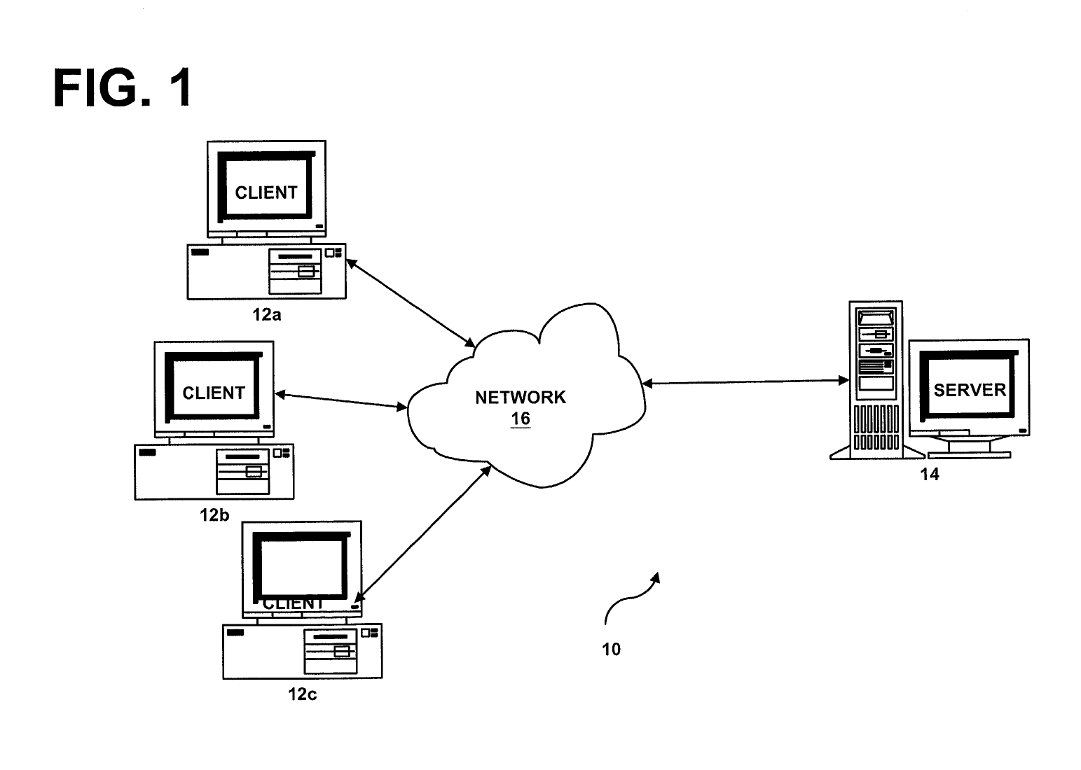

Referring now to the drawings, wherein like reference numerals designate corresponding parts throughout the drawings, FIG. 1 is a block diagram that portrays a diagram of a network that illustrates the flexibility, expandability, and platform independence in which the present decision support system may be implemented. Referring to FIG. 1, a series of client computers 12a, 12b, 12c, are connected to a server computer 14 via a network 16. The network 16 may be, for example, but is not limited to, a dial-in network, local area network (LAN), wide area network (WAN), public switched telephone network (PSTN), Intranet, Internet, Ethernet type networks, and the like. The client computers 12a, 12b, 12c (hereinafter, 12) may be located within a LAN, WAN, PSTN, Intranet, Internet, Ethernet type networks, or the like. It should be noted that the number of client computers and server computers may differ from the number presently illustrated. Further, it should also be noted that, that the preferred embodiment of the invention describes the functionality provided by a server computer 14.

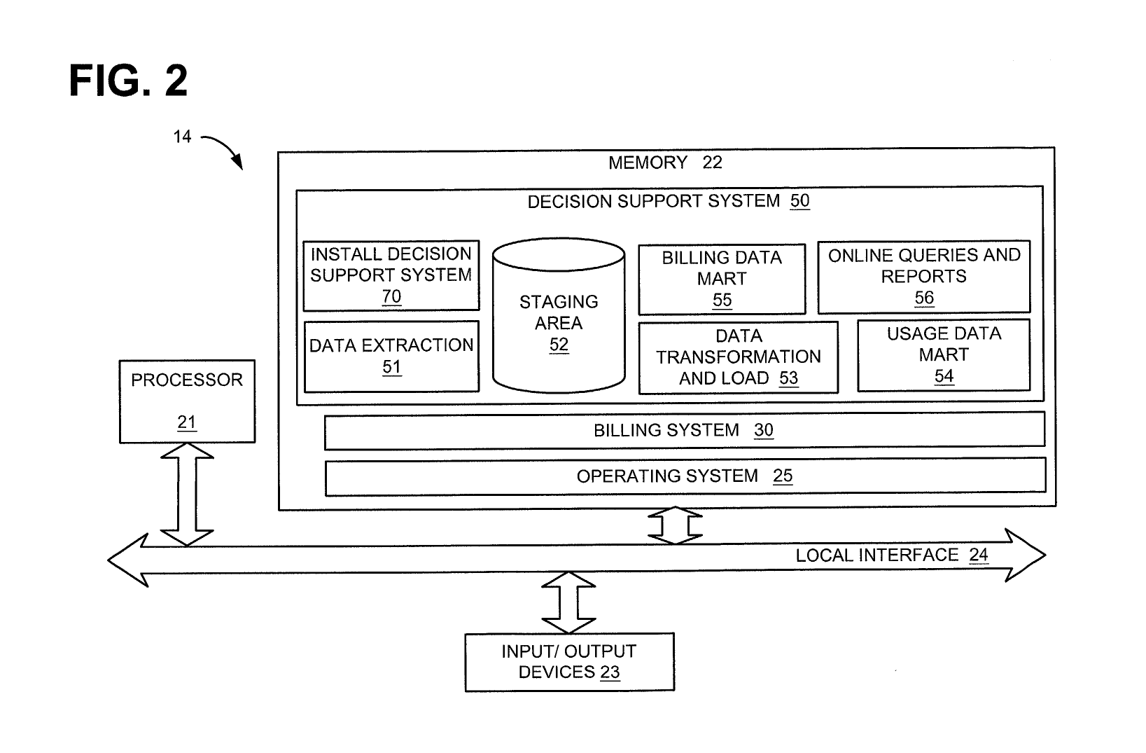

An example of a general-purpose computer that can implement the decision support system of the present invention is shown in FIG. 2. The decision support system, denoted by reference numeral 50, includes data extraction 51, staging area 52, data transformation and loading 53, usage data mart 54, billing data mart 55, online queries and reports 56 and an installed decision support system 70. The decision support system 50 of the invention can be implemented in software (e.g., firmware), hardware, or a combination thereof. In one embodiment, the decision support system 50 is implemented in software, as an executable program, and is executed by a special or general purpose digital computer, such as a personal computer (PC, IBM-compatible, Apple-compatible, or otherwise), workstation, minicomputer, personal digital assistant (PDA) or mainframe computer.

Generally, in terms of hardware architecture, as shown in FIG. 2, the server computer 14 include a processor 21, memory 22, and one or more input and/or output (I/O) devices 23 (or peripherals) that are communicatively coupled via a local interface 24. The local interface 24 can be, for example but not limited to, one or more buses or other wired or wireless connections, as is known in the art. The local interface 24 may have additional elements, which are omitted for simplicity, such as controllers, buffers (caches), drivers, repeaters, and receivers, to enable communications. Further, the local interface 24 may include address, control, and/or data connections to enable appropriate communications among the aforementioned components.

The processor 21 is a hardware device for executing software that can be stored in memory 22. The processor 21 can be virtually any custom made or commercially available processor, a central processing unit (CPU) or an auxiliary processor among several processors associated with the computer 14, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 22 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 22 may incorporate electronic, magnetic, optical, and/or other types of storage media. Note that the memory 22 can have a distributed architecture, where various components are situated remote from one another, but can be accessed by the processor 21.

The software in memory 22 may include one or more separate programs, each of which comprises an ordered listing of executable instructions for implementing logical functions. In the example of FIG. 2, the software in the memory 22 includes the decision support system 50 and a suitable operating system (O/S) 25.

A non-exhaustive list of examples of suitable commercially available operating systems 25 is as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 25 essentially controls the execution of other computer programs, such as the decision support system 50, and provides scheduling, input-output control, file and data management, memory management, and communication control and related services.

The decision support system 50 may be a source program, executable program (object code), script, or any other entity comprising a set of instructions to be performed. When a source program, then the program is usually translated via a compiler, assembler, interpreter, or the like, which may or may not be included within the memory 22, so as to operate properly in connection with the O/S 25. Furthermore, the decision support system 50 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, and Ada.

The I/O devices 23 may include input devices, for example but not limited to, a keyboard, mouse, scanner, microphone, etc. Furthermore, the I/O devices 23 may also include output devices, for example but not limited to, a printer, display, etc. Finally, the I/O devices 23 may further include devices that communicate both inputs and outputs, for instance but not limited to, a modulator/demodulator (modem, for accessing another device, system, or network), a radio frequency (RF) or other transceiver, a telephonic interface, a bridge, a router, etc.

If the server 14, is a PC, workstation, or the like, the software in the memory 22 may further include a basic input output system (BIOS) (omitted for simplicity). The BIOS is a set of essential software routines that initialize and test hardware at startup, start the O/S 25, and support the transfer of data among the hardware devices. The BIOS is stored in ROM so that the BIOS can be executed when the server 14 is activated.

When the server 14 is in operation, the processor 21 is configured to execute software stored within the memory 22, to communicate data to and from the memory 22, and to generally control operations of the computer 14 pursuant to the software. The decision support system 50 and the O/S 25 are read, in whole or in part, by the processor 21, perhaps buffered within the processor 21, and then executed.

When the decision support system 50 is implemented in software, as is shown in FIG. 2, it should be noted that the decision support system 50 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The decision support system 50 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the decision support system 50 is implemented in hardware, the decision support system 50 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

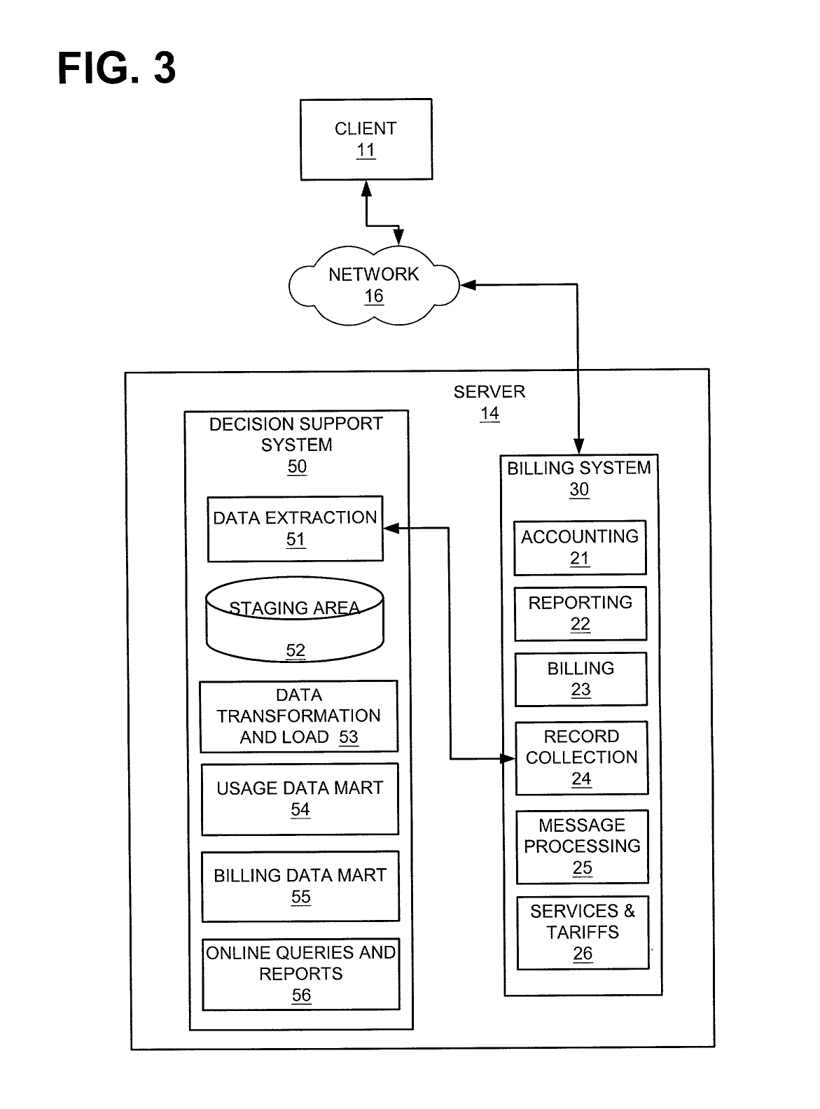

Illustrated in FIG. 3 is an example of an architecture of the decision support system 50 interacting with other systems. The goal is to provide a customer with the ability to make informed business decisions based on key data from a target database. There are three major components to the decision support system, which together allow for distraction, collection and analysis of targeted data. These components are optimized for rapid data access including online transactional processing and ad hoc request capabilities. The first component is the data extraction component 51 that extracts data from the target database and transfers it to the decision to support the staging area 52 in the decision support system 50. Once the data is stored in the staging area 52, the support system 50 then performs a data transformation and load. The data transformation and load 53 provides the ability to transfer and load optionally structured data into the data marts. The data marts make up the dimensional model consisting of fact tables and dimensional tables sometimes referred to as star joined or stars scheme up. These tables contain data, which the decision support system queries and runs reports on. The usage data mart 54 takes as its key facts, the duration and rated amount of individual records. Queries can be performed to study record amounts by various customer attributes, for example and not limited to, activation/deactivation data, customer edge, gender, price group, geographic region, credit rating, etc. These customer attributes vary by contract and also include contract attributes such as, but not limited to, a rate plan for a calling card plan, activation, deactivation, dates of the calling card plan, the service of a example calling card plan, and by various call record attributes such as call type, cgi, market call date and time, etc. Using the usage data mart, one can usually generate usage-related queries to assist the customer in the work analysis to evaluate product success and determined network load. For example, in an example calling card system, the usage data mart can be used to determine service popularity by performing a query that maps the total call volume by service, rate plan and activation date. It is also possible to evaluate geographic usage load by performing a query that maps the total call volume by geographic region and call/date of time.

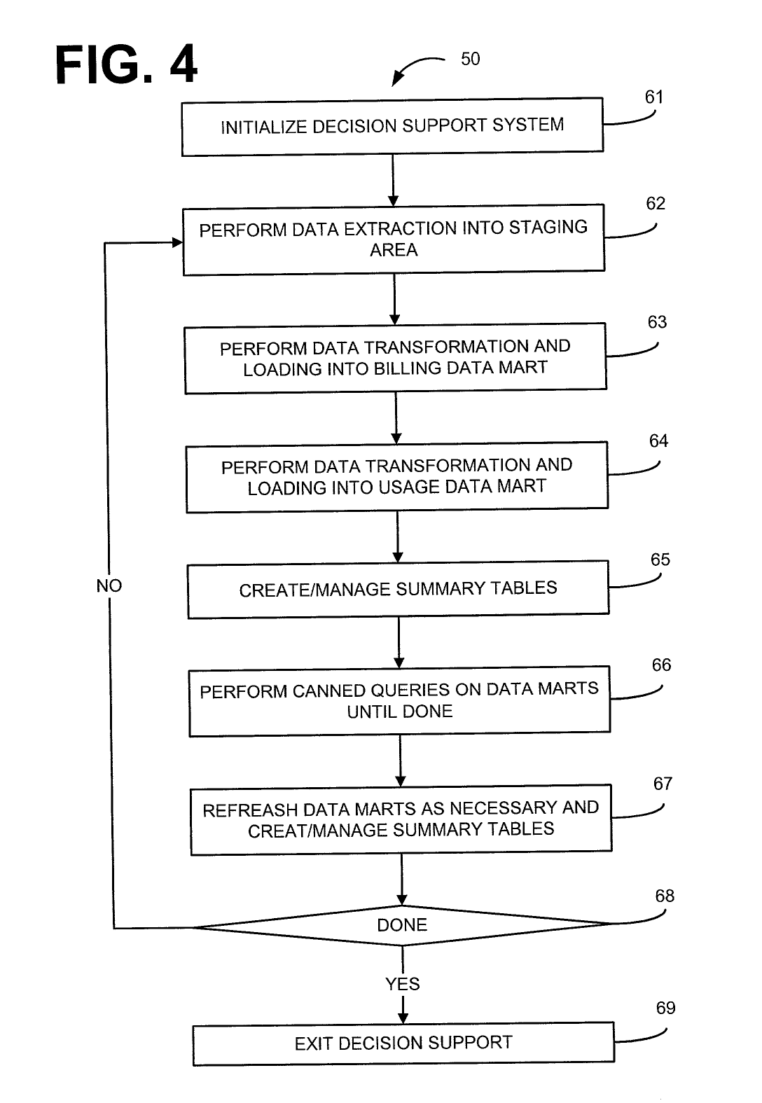

The data marts utilize and store all of the information available for research. Unlike data warehouses, data marts are focused on the particular topics, e.g., in this disclosure, billing related information for a calling card plan. Since the data marts contain only specific subsets of production database, they are smaller and thus easier to manage. Data can then be structured in a way that suits the needs of the analyzing user, which then simplifies research and dramatically reduces response times. The data marts utilized by the decision support system 50 are based on the star schemer that basically consists of a very large fact table that is surrounded by dimensional tables. These fact tables contain data to be analyzed, while the dimensional tables provide the selected criteria. As depicted in FIG. 3, the example billing system 30 is a standard billing system that provides for the accounting of balances via the accounting module 21 and the reporting of those balances utilizing the reporting module 22. A billing module 23 is capable of creating bills to send to customers. The message processing module 25 maintains a call history and prepaid event history in the billing system. The services and tariffs process module 26 provides prepaid and postpaid tariff model administration and stores these models for access by their rated functions. The service and tariffs process 26 may also include processing for mapping and synchronizing tariff data stored on both the decision support system 50 and the billing system 20. The operation of the decision support system will now be discussed herein with regard to FIG. 4.

Illustrated in FIG. 4 is a flow diagram illustrating an example of the process flow of the decision support system 50 of the present invention. First, the decision support system 50 is initialized at step 61. At step 62, the decision support system performs the data extraction of the staging area. At step 63, the data transformation and loading is performed into the billing data mart.

At step 64, the decision support 50 then performs the data transformation and loading into the usage data mart 54. At step 65, the decision support system then creates and manages summary tables for the billing data mart 55 and usage data mart. At step 66, the decision support 50 then performs canned queries on the data mart utilizing the online queries and reports. At step 67, the decision, support system then refreshes the data marts as necessary and creates and manages summary tables.

At step 68, the decision support system 50 then determines if there are more databases to be processed. If it is determined at step t8 that there are more databases to be processed, the decision support system 50 then returns to repeat steps 62-68. However, if it is determined that there are no more databases to be processed, the decision support system 50 then exits at step 69.

The foregoing description has been presented for purposes of illustration and description. It is not intended to be exhaustive or to limit the invention to the precise forms disclosed. Modifications or variations are possible in light of the above teachings.

The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A system for providing a decision support system, comprising:
means for acquiring system data;
means for transforming the system data into searchable data; and
means for providing queries on the searchable data.

2. The system of claim 1, further comprising:
means for loading searchable data into a billing data mart.

3. The system of claim 2, further comprising:
means for loading searchable data into a usage data mart.

4. The system of claim 3, further comprising:
means for creating summary tables of the billing data mart and usage data mart.

5. The system of claim 4, further comprising:
means for refreshing the billing data mart and usage data mart.

6. A method for providing a decision support system, said method comprising the steps of:
acquiring system data;
transforming the system data into searchable data; and
providing queries on the searchable data.

7. The method of claim 6, further comprising the step of:
loading searchable data into a billing data mart.

8. The method of claim 7, further comprising the step of:
loading searchable data into a usage data mart.

9. The method of claim 8, further comprising the step of:
creating summary tables of the billing data mart and usage data mart.

10. The method of claim 9, further comprising the step of:
refreshing the billing data mart and usage data mart.

11. A computer readable medium for providing a decision support system, comprising:
logic for acquiring system data;
logic for transforming the system data into searchable data; and
logic for providing queries on the searchable data.

12. The computer readable medium of claim 11, further comprising:
logic for loading searchable data into a billing data mart.

13. The computer readable medium of claim 12, further comprising:
logic for loading searchable data into an usage data mart.

14. The computer readable medium of claim 13, further comprising:
logic for creating summary tables of the billing data mart and usage data mart.

15. The computer readable medium of claim 14, further comprising:
logic for refreshing the billing data mart and usage data mart.

16. A system for providing a decision support system, comprising:
an input mechanism that acquires system data;
a transformation mechanism that transforms the system data into searchable data; and
a reporter that provides queries on the searchable data.

17. The system of claim 16, wherein the input mechanism loads the searchable data into a billing data mart.

18. The system of claim 17, wherein the input mechanism loads the searchable data into an usage data mart.

19. The system of claim 18, further comprising:
a summary mechanism that creates a plurality of summary tables for the billing data mart and usage data mart.

20. The system of claim 19, wherein the input mechanism refreshes the billing data mart and usage data mart.
